(19) United States
(12) Patent Application Publication
(10) Pub. No.: US 2025/0246039 A1
(43) Pub. Date: Jul. 31, 2025

(54) AUTOMATED GRADING AND ASSESSMENT OF COINS

(71) Applicant: VIRGINIA TECH INTELLECTUAL PROPERTIES, INC., Blacksburg, VA (US)

(72) Inventors: Luke F. Lester, Blacksburg, VA (US); Creed F. Jones, Christiansburg, VA (US); Jianzhu Chen, Blacksburg, VA (US); Michael K. Trail, Centreville, VA (US); Madalyn A. Killian, Blacksburg, VA (US); Mohammed Humadi, Manassas, VA (US); Christopher Fritsch, Chesapeake, VA (US)

(21) Appl. No.: 18/853,880

(22) PCT Filed: Apr. 19, 2023
(86) PCT No.: PCT/US23/65948

§ 371 Date: Oct. 3, 2024

Related U.S. Application Data
(60) Provisional application No. 63/363,207, filed on Apr. 19, 2022.

(51) Int. Cl. G07D 5/00; G06V 20/60

(52) U.S. Cl. CPC G07D 5/005; G06V 20/60

(57) ABSTRACT

Disclosed are various embodiments for automatically grading and assessing coins. In one embodiment, a machine learning model is trained based at least in part on first images respectively depicting coins of a particular type. The coins are manually assigned a respective coin classification. A second image is received depicting a different coin of the particular type. An analysis of the second image is performed based at least in part on the machine learning model. A particular coin classification is assigned to the different coin based at least in part on the analysis of the second image.

### CROSS-REFERENCE TO RELATED APPLICATION

This application claims the benefit of and priority to U.S. Provisional Patent Application No. 63/363,207 filed Apr. 19, 2022, entitled “AUTOMATED GRADING AND ASSESSMENT OF COINS,” the contents of which being incorporated by reference in their entirety herein.

### BACKGROUND

Coin collectors across the nation send their coins in for manual review and grading by highly trained experts, who are few in number, in order to determine the potential value of their collection. This grading process is generally limited to as little as four reputable grading companies, each of which can take 30-60 days to grade coins that are submitted. The grading process is entirely manual, rather than by machine, which leads to inconsistencies in the assessment. Even coins that look vastly different can have the exact same grade, which is especially an issue when comparing coins graded by different companies. These inconsistencies in coin grading can have an impact of hundreds, or even thousands, of dollars on the value of the coin.

### BRIEF SUMMARY

Various embodiments are disclosed for automatically grading and assessing coins. A first embodiment includes a computer-implemented method for automatically grading coins. The method also includes training a machine learning model based at least in part on a plurality of first images respectively depicting a plurality of coins of a particular type, where individual ones of the plurality of coins are manually assigned a respective coin classification. The method also includes receiving a second image depicting a different coin of the particular type. The method also includes performing an analysis of the second image based at least in part on the machine learning model. The method also includes automatically assigning a particular coin classification to the different coin based at least in part on the analysis of the second image.

A second embodiment includes a computer-implemented method for automatically verifying coin classifications. The method also includes training a machine learning model based at least in part on a plurality of first images respectively depicting a plurality of coins of a particular type, where individual ones of the plurality of coins being manually assigned a respective coin classification. The method also includes receiving a second image depicting a different coin of the particular type, and the second image is associated with a proposed classification. The method also includes performing an analysis of the second image based at least in part on the machine learning model. The method also includes automatically determining whether the different coin is correctly classified with the proposed classification based at least in part on the analysis.

A third embodiment includes a system for automatically grading coins. The system includes at least one computing device configured to at least: train a machine learning model based at least in part on a plurality of first images respectively depicting a plurality of coins. Individual ones of the plurality of coins are manually assigned a respective coin classification. The computing device is further configured to at least receive a second image depicting a different coin. The computing device is further configured to at least perform an analysis of the second image based at least in part on the machine learning model. The computing device is further configured to at least automatically assign a particular coin classification to the different coin based at least in part on the analysis of the second image.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 shows one example of an image of a coin that may be automatically assessed and graded according to one or more embodiments of the present disclosure.

FIG. 2 shows an example networked environment according to one or more embodiments of the present disclosure.

FIGS. 3-5 are flowcharts that provide examples of the operation of portions of a coin assessment application executed in a computing environment in the networked environment of FIG. 3 according to various embodiments of the present disclosure.

### DETAILED DESCRIPTION

The embodiments described herein are directed to computer-based methods for image processing and automated grading and assessment of collectible coins. The present disclosure employs a machine-learning-based analysis of coin images to score coins based at least in part on one or more of wear, circulation status, color, authenticity, luster, defects, and/or other factors.

The valuation of collectible coins is typically based upon a coin's grade on a standardized scale. Several coin grading scales are in use, including the Sheldon coin grading scale, the American Numismatic Association (ANA) coin grading scale (based on the Sheldon scale), the Certified Acceptance Corporation (CAC) coin grading scale, various European coin grading scales, and so on. The Sheldon scale is a 70-point scale that ranks coins from poor (P-1) to perfect mint state (MS-70). Grades 1-59 are uncirculated grades, while grades 60-70 are uncirculated, or mint state, grades.

For example, in the Sheldon scale, a coin graded poor (1) may be identifiable but with key features worn smooth, or the coin may be badly corroded. A coin graded good (4) may have a slightly worn rim, a visible but faint design, with various parts worn flat. A coin graded very good (8) may have slight visible detail, such as two to three letters of the word “LIBERTY” showing. A coin graded fine (12) may have sharp lettering, with all letters of the word “LIBERTY” being visible but potentially weak, and the coin may show moderate to considerable wear. A coin graded very fine (25) may show all lettering and major features but have light to moderate, but even, wear. A coin graded extremely fine (40) may have only light wear on the highest points on the coin, and the coin may have traces of mint luster. A coin graded mint state (60) may have a washed-out mint luster, nicks, but no trace of wear. A coin graded mint state (70) may have no trace of wear, handling, scratches, or contact with other coins at 5× magnification, and the coins may be bright with original luster. These are merely selected examples of the grades, and each grade may be associated with a corresponding explanation of defining features.

Traditional coin grading is exclusively a manual process. Grading services employ experienced graders who are trained to apply, for example, the ANA or Sheldon grading system. Reference literature may include detailed descriptions of features of a specific type of coin that may warrant placement in one grade or another. In some cases, the reference literature may include color-coded heat maps that indicate by color relatively important regions or features of the coin that contribute to defining a certain grade. Grade characteristics may vary based upon the type of coin, such as Lincoln pennies. Indian Head pennies, Morgan dollars, Barber quarters, Washington quarters, and so forth. Different types of coins have different characteristics such as sizes, shapes, material, features, etc., and the grading criteria may refer to these characteristics for the particular coin type.

A substantial problem with traditional coin grading is inconsistency. Two graders may assign different grades to an identical coin because the grading process is subjective. For example, with respect to an Indian Head cent with a feather headdress, one grader may look at all the feathers, while another grader may look at the first two feathers only, leading to potential inconsistency in grading. In some cases, a grader may be so enamored with some feature of a coin (e.g., that it was produced in the Carson City mint) that the grader completely misses a spot of corrosion or a scratch that would impact the grade. Consequently, the coin is overgraded, or given too high of a grade. Conversely, in other cases, a grader may be so fixated on a particular defect that the grader misses that the coin is otherwise in better condition. This may lead to undergrading the coin, or assigning the coin too low a grade. When a coin is overgraded, a buyer may end up paying an unfairly high price for the coin. When a coin is undergraded, a buyer may end up paying an unfairly low price for the coin.

Various embodiments of the present disclosure introduce a computer-based automated assessment and grading system for collectable coins that removes the subjectivity from the grading process. A machine learning model is trained on a data set of reference coin images for a certain type of coin, where the reference coin images are associated with a manually curated grade on a particular grading scale. Subsequently, an image of a subject coin of the certain type can be presented to the machine learning model. The machine learning model can then automatically assign a grade to the subject coin. Alternatively, the image of the subject coin can be presented to the machine learning model along with a proposed grade. The machine learning model can then respond whether the proposed grade is too low or too high. Accordingly, the system can function as an objective validation for manually assigned grades. Although the present disclosure makes reference to grades on the Sheldon scale, it is understood that the disclosure can be adapted to any coin grading scale.

Coins have unique artifacts of wear compared to other collectibles. For example, trading cards may have folded corners and worn edges, but coin wear is manifested in a wearing down of the high points of the surface features, nicks, scratches, corrosion, and so on. It is also important that coins are intentionally minted to be identical, so the grading for a certain type of coin may be extended to all coins of that certain type.

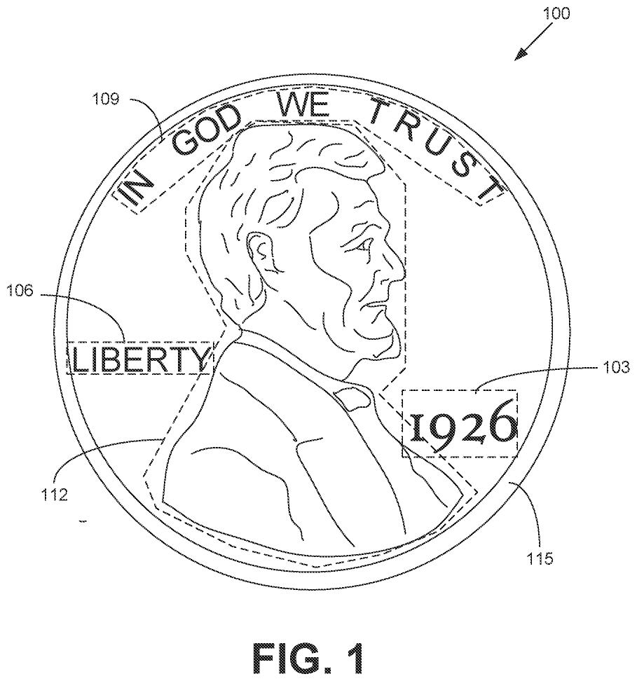

Turning now to FIG. 1, show is one example of an image of a coin 100 that may be automatically assessed and graded according to various embodiments. In this non-limiting example, the coin 100 is a Lincoln penny. As can be seen in FIG. 1, various features from the image of the coin 100 can be automatically recognized and extracted. The features are shown by way of bounding boxes for purposes of illustration only. For example, a year 103 that the coin 100 was minted may be recognized, the word 106 “LIBERTY” may be recognized, the phrase 109 “IN GOD WE TRUST” may be recognized, a portrait 112 may be recognized, a rim 115 may be recognized, and so on. The wear on any number of these features, the coin 100 in its entirety, or a combination of regions of the coin 100, may contribute to the grade of the coin 100. The height of the features, and the corresponding wear, may be approximated at least in part by shadows in a two-dimensional image.

It is noted that the combination of features present on a coin 100 and their locations and sizes may vary based upon the type of the coin 100. For example, the features on a Washington quarter will be different from the features on a Barber quarter. Also, coins 100 may be redesigned from time to time, so the type of the coin 100 may be specific to a year or range of years.

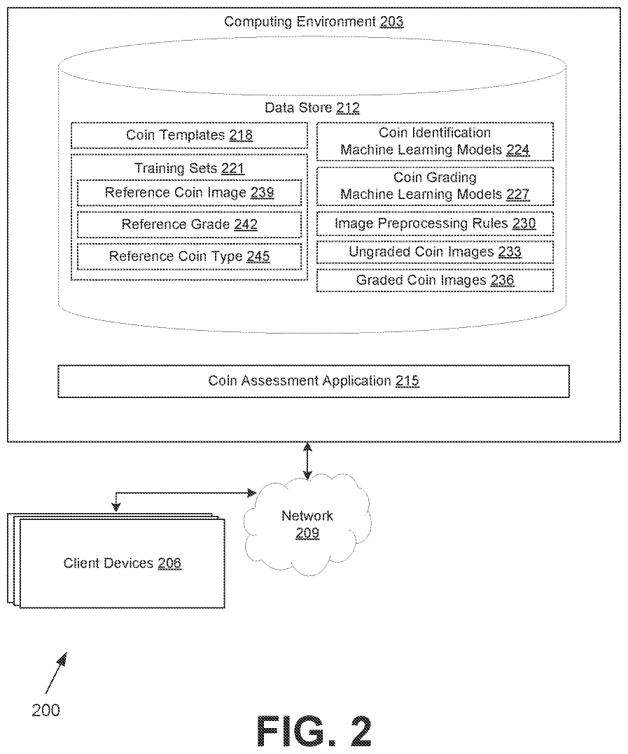

With reference to FIG. 2, shown is a networked environment 200 according to various embodiments. The networked environment 200 includes a computing environment 203 and one or more client devices 206, which are in data communication with each other via a network 209. The network 209 includes, for example, the Internet, intranets, extranets, wide area networks (WANs), local area networks (LANs), wired networks, wireless networks, cable networks, satellite networks, or other suitable networks, etc., or any combination of two or more such networks.

The computing environment 203 may comprise, for example, a server computer or any other system providing computing capability. Alternatively, the computing environment 203 may employ a plurality of computing devices that may be arranged, for example, in one or more server banks or computer banks or other arrangements. Such computing devices may be located in a single installation or may be distributed among many different geographical locations. For example, the computing environment 203 may include a plurality of computing devices that together may comprise a hosted computing resource, a grid computing resource, and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. Also, various data is stored in a data store 212 that is accessible to the computing environment 203. The data store 212 may be representative of a plurality of data stores 212 as can be appreciated. The data stored in the data store 212, for example, is associated with the operation of the various applications and/or functional entities described below.

The components executed on the computing environment 203, for example, include a coin assessment application 215 and other applications, services, processes, systems, engines, or functionality not discussed in detail herein. The coin assessment application 215 is executed to perform an automatic assessment and grading for an image of a coin. The output may be a coin grade on a scale such as the Sheldon scale, potentially in combination with a confidence level of the determination. In some scenarios, the output may be a description of coin features and wear automatically identified and recognized from the coin image. In some scenarios, the coin assessment application 215 may be executed to receive a coin image in combination with a proposed grade, and the coin assessment application 215 may determine whether the coin represented in the coin image is likely to be undergraded or overgraded.

The data stored in the data store 212 includes, for example, one or more coin templates 218, one or more training sets 221, one or more coin identification machine learning models 224, one or more coin grading machine learning models 227, one or more image preprocessing rules 230, one or more ungraded coin images 233, one or more graded coin images 236, and potentially other data.

The images described herein, such as the ungraded coin images 233, the graded coin images 236, and so forth, may be two-dimensional rasters captured using a 1200 dots per inch (dpi) resolution scan at an eight-bit-per-color (red, green, and blue (RGB)) color depth. Other resolutions, color depths, and color schemes may be used in other implementations. In some implementations, the images may correspond to infrared images, ultraviolet images, ultrasound scans, and three-dimensional images. In some implementations, the images may comprise a video of a coin being tilted relative to a light source, which may be useful in evaluating coin characteristics such as luster, for example.

The coin templates 218 may correspond to parameters used to locate and extract features from particular types of coins for automated evaluation. For example, respective coin templates 218 may be created for Lincoln zinc pennies in 1943, Washington quarters from 1932 through 1964, Mercury dimes, Eisenhower dollars, etc. The coin templates 218 may identify where on the coin image features such as the year, portrait, stars, text, or other features are located. In some embodiments, the coin templates 218 are manually curated for each coin type.

The training sets 221 are reference or “golden” data sets used to train machine learning models. The training sets 221 may be specific to a certain coin type and year (or year range). A training set 221 may include a number of reference coin images 239, each in association with a reference grade 242 and a reference coin type 245. The reference grade 242 is assigned to the coin depicted in the reference coin image 239 by a trained grader applying the grading criteria. In some implementations, the training set 221 may be curated to remove outliers, or graded coins that include some unusual defect specific to that coin.

The coin identification machine learning model 224 may be a machine learning model that is trained to automatically identify a coin type given a coin image. As a non-limiting example, the coin identification machine learning model 224 may automatically recognize that an image of a coin is of a Susan B. Anthony dollar. Subsequently, the image may be passed to a corresponding coin grading machine learning model 227 for grading. The coin identification machine learning model 224 may be trained based on a plurality of the training sets 221 for different reference coin types 245.

The coin grading machine learning models 227 are each specific to a particular coin type and year (or year range) and are trained based on the training set 221 corresponding to the particular coin type and year (or year range). Given a coin image, the coin grading machine learning model 227 outputs a grade potentially in combination with a confidence level. In some implementations, the coin grading machine learning model 227 may output other classifications such as toning, brightness, eye appeal, and so on. In addition to a numerical grade or a classification, the coin grading machine learning model 227 may also output one or more characteristics of the coin in the image. For example, the coin grading machine learning model 227 may output that the coin shows a nick, a scratch, an area of corrosion, and/or other characteristics that may affect grading or valuation. In some embodiments, the coin grading machine learning models 227 and the coin identification machine learning models 224 may comprises classification machine learning models such as support vector machines (SVMs), neural networks, K-nearest neighbor algorithms, and other types of machine learning models. Insofar as coins typically have two flat faces, a coin grading machine learning model 227 may be trained to classify coins based at least in part on both the coin's reverse and the coin's obverse.

The image preprocessing rules 230 may correspond to a rule set that controls preprocessing of the images, such as the ungraded coin images 233, the graded coin images 236, and the reference coin images 239. Various types of preprocessing may be performed on the images before the images are presented for training or for classification by a machine learning model. Preprocessing may include, for example, contrast equalization, Gaussian filtering, conversion from color to grayscale or black-and-white, a color analysis, glare removal using a clamp transformation on the brightness of the image, and other forms of preprocessing and image clean-up algorithms.

The ungraded coin images 233 are coin images that are submitted for initial grading and/or analysis by the coin assessment application 215. The graded coin images 236 are coin images associated with a proposed grade, which are also submitted for analysis by the coin assessment application 215. In the case of the graded coin images 236, the coin assessment application 215 may determine whether the proposed grade is lesser or higher than a grade that the coin assessment application 215 would assign the coin image.

The client device 206 is representative of a plurality of client devices that may be coupled to the network 209. The client device 206 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The client device 206 may include a display comprising, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 206 may be configured to execute various applications such as a client application and/or other applications. The client application may be executed in a client device 206, for example, to access network content served up by the computing environment 203 and/or other servers, thereby rendering a user interface on the display. To this end, the client application may comprise, for example, a browser, a dedicated application, etc., and the user interface may comprise a network page, an application screen, etc. For example, a user may utilize the client application to upload a graded coin image 236 and/or an ungraded coin image 233 for analysis by the coin assessment application 215. The client device 206 may be configured to execute applications beyond the client application such as, for example, email applications, social networking applications, word processors, spreadsheets, and/or other applications.

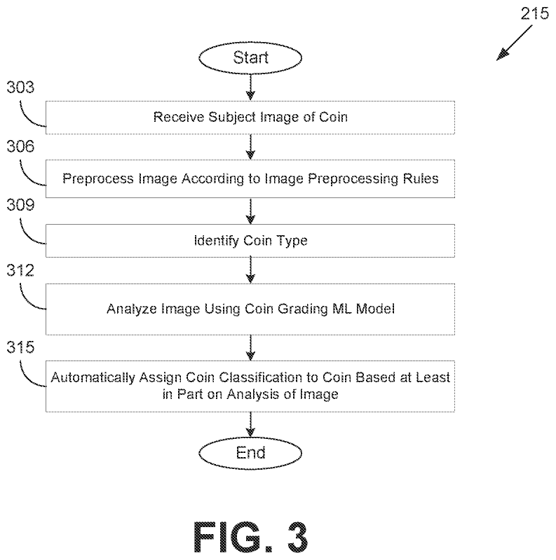

Referring next to FIG. 3, shown is a flowchart that provides one example of the operation of a portion of the coin assessment application 215 according to various embodiments. It is understood that the flowchart of FIG. 3 provides merely an example of the many different types of functional arrangements that may be employed to implement the operation of the portion of the coin assessment application 215 as described herein. As an alternative, the flowchart of FIG. 3 may be viewed as depicting an example of elements of a method implemented in the computing environment 203 (FIG. 2) according to one or more embodiments.

Beginning with box 303, the coin assessment application 215 receives a subject image of a coin. In various embodiments, the image may comprise an RGB image, an ultrasound image, an ultraviolet image, an infrared image, and/or another type of image. In one example, the image is an RGB scan of the image at 1200 dpi with eight-bits-per-color color depth. The coin assessment application 215 may receive two images, corresponding to both the obverse (i.e., heads) and the reverse (i.e., tails) of the same coin. In some cases, images of both the obverse and the reverse of the coin may be combined into a single image. In some cases, the coin may be scanned or photographed against a white background or within a coin holder. In some cases, the image may comprise a video that shows the coin being tilted in front of a stationary light source, or a video (i.e., a collection of images) that shows the coin being illuminated from a moving light source at different angles. The coin in the image is typically circular in shape, but for international coinage, the coin may have projections, holes, and/or other variations from a circular shape.

In box 306, the coin assessment application 215 preprocesses the subject image (or images) using one or more image preprocessing rules 230 (FIG. 2). One or more of the image preprocessing rules 230 may apply processing that is aimed at cleaning up the image. For example, the image preprocessing may fill the background to a solid color or transparency and/or remove artifacts of a coin holder. The image preprocessing rules 230 may also specify functions such as contrast equalization, Gaussian filters, Sobel edge detection, color transformations, glare removal using a clamp transformation on the brightness, inpainting, straightening, rotation, scaling, cropping, and so on.

In box 309, the coin assessment application 215 identifies the type of coin from the image. In some cases, the image may be tagged with a coin type, either in metadata or information passed to the coin assessment application 215 along with the image. In other cases, the coin assessment application 215 may apply an initial analysis using a coin identification machine learning model 224 (FIG. 2) to automatically identify the coin type from characteristics of the coin shown in the image. The coin identification machine learning model 224 is trained based upon a training set 221 (FIG. 2) of reference coin images 239 (FIG. 2) that are manually associated to respective reference coin types 245 (FIG. 2). Identifying the coin type may be significant because grading or classification may differ between different coin types. For example, copper coinage may be processed differently from silver coinage. Bimetallic coins (e.g., coins with an inset of a different metal surface) may be processed differently than coins having a single metal surface.

In some scenarios, the coin assessment application 215 may automatically identify a particular variety of the type of coin by performing an initial analysis. For example, the variety may constitute a die or die pairing that offers a distinctive feature that is not a normal part of the coin design. In some scenarios, the coin assessment application 215 may automatically identify a mint error on the coin by performing an initial analysis. Such mint errors may comprise, for example, die caps, wrong planchet, off-centers, broadstrikes, partials collars, uniface strikes, brockages, double and triple struck, indents, die adjustment errors, and other types of mint errors. The initial analyses may be based in part on the coin templates 218 associated with the particular coin type and/or identified from generic features generally associated with these varieties or mint errors across multiple coin types.

In box 312, the coin assessment application 215 analyzes the subject image using a coin grading machine learning model 227 (FIG. 2) that is specifically trained on the type of coin. In another embodiment, the coin grading machine learning model 227 may be trained based at least in part on one or more other coin types. In analyzing the image, the coin assessment application 215 may extract features for analysis by the coin grading machine learning model 227 using a coin template 218 that defines features and locations for the specific coin type. For example, the coin template 218 may indicate a region in a scaled and preprocessed image that is to correspond to the word “LIBERTY,” a region that is to correspond to a star, a region that is to correspond to the date or year of the coin. Pattern matching targets may be chosen based upon criteria such as sharp pointed edges, edges in multiple different directions, targets from different regions of the coin susceptible to wear, targets that have a minimal slope and are largely a flat raised surface off the coin, etc.

In some scenarios, wear for various features may be determined based at least in part on extracting depth data inferred from shadows present in the image, using a shape from shading estimation. In some scenarios, the presence of luster may determined through examination of multiple images of the coin at different angles or with different illumination. The coin assessment application 215 may determine sharpness, illumination, content, hue/saturation/lightness (HSL) values, and/or other features of a region for analysis by the coin grading machine learning model 227.

The features may be coin specific as identified in the coin template 218. In some cases, the analysis may include pattern matching. In another example, the coin assessment application 215 may use image transforms to analyze the periodicity level of wheat stalks on a Lincoln Wheat cent, the periodicity level of the Lincoln Memorial stairs on a Lincoln Memorial cent, and so forth. Image transforms may comprise a horizontal one-dimensional Fourier transform, a vertical one-dimensional Fourier transform, and so on. In one scenario, the average of all one-dimensional output arrays may be calculated, and a ratio of local maxima of harmonics can be determined, which may then be plotted versus the Sheldon scale to determine a correlation between the Sheldon scale and the ratio of local maxima of harmonics.

The coin assessment application 215 may analyze colors in the image by converting RGB values to HSL values, which are then displayed in a histogram. The coin assessment application 215 may then perform a statistical analysis on the histogram to extract significant values. The values may then be compared against a color scale associated with color grading, and a correlation may be determined between the HSL analysis and the actual Sheldon scale color rating.

In one example, the coin assessment application 215 determines a date of the coin from the image and automatically assigns a particular coin classification to the coin based at least in part on the date. In one example, the coin assessment application 215 determines a level of wear of the coin from the image and automatically assigns a particular coin classification to the coin based at least in part on the level of wear. In one example, the coin assessment application 215 determines an HSL value of the coin from the image and automatically assigns a particular coin classification to the coin based at least in part on the HSL value. In one example, the coin assessment application 215 applies a transform to straighten a feature of the coin from the image, crops the image around the feature, and performs a Fourier transform on the cropped image. In one example, the coin assessment application 215 identifies text from the coin in the image and then crops the image around the text.

In box 315, the coin assessment application 215 automatically assigns a coin classification to the coin based at least in part on the analysis of the image. The coin classification may, for example, comprise a grade on the Sheldon scale or a different scale, a degree of toning, a parameter indicative of color, a parameter indicative of eye appeal, and/or a classification involving wear level, corrosion, circulation status, identifiability, whether the coin has likely been cleaned, and so on. It is noted that the coin classification may be based at least in part on a classification of each of both sides of the coin. The coin assessment application 215 may also assign a confidence level to the coin classification, indicating the level of certainty that the coin confidence level is correct. The confidence level may be output alongside the coin classification. Thereafter, the operation of the portion of the coin assessment application 215 ends.

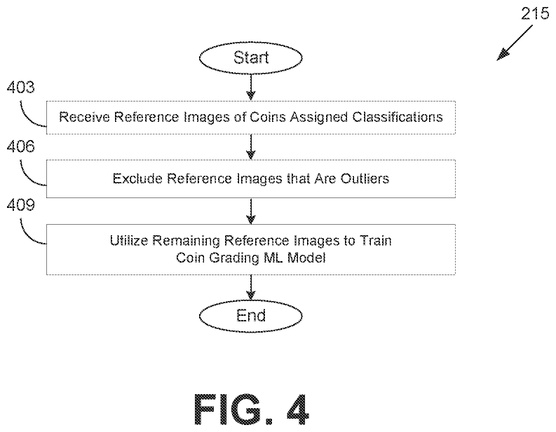

Moving on to FIG. 4, shown is a flowchart that provides one example of the operation of another portion of the coin assessment application 215 according to various embodiments. It is understood that the flowchart of FIG. 4 provides merely an example of the many different types of functional arrangements that may be employed to implement the operation of the portion of the coin assessment application 215 as described herein. As an alternative, the flowchart of FIG. 4 may be viewed as depicting an example of elements of a method implemented in the computing environment 203 (FIG. 2) according to one or more embodiments.

Beginning with box 403, the coin assessment application 215 receives a plurality of reference coin images 239 (FIG. 2) that are assigned respective reference grades 242 (FIG. 2) or other classifications.

In box 406, the coin assessment application 215 excludes any of the reference coin images 239 that are outliers. For example, the coin may represent a special case with a defect that would be difficult to grade. Including such an image in the training set 221 (FIG. 2) might bias the training of the machine learning model inappropriately. In various embodiments, such outliers may include cleaned coins, double die coins, and coins that display other anomalies.

In box 409, the coin assessment application 215 utilizes the remaining reference coin images 239 to train respective coin grading machine learning models 227 to be capable of assigning grades or classifications to ungraded coin images 233, or to be capable of determining whether a proposed grade or classification is likely correct or incorrect. The coin assessment application 215 may train the coin grading machine learning models 227 for automation and speed, and the coin grading machine learning models 227 may be trained based at least in part on accepted coin classifications that the coin grading machine learning models 227 have previously produced. Thereafter, the operation of the portion of the coin assessment application 215 ends.

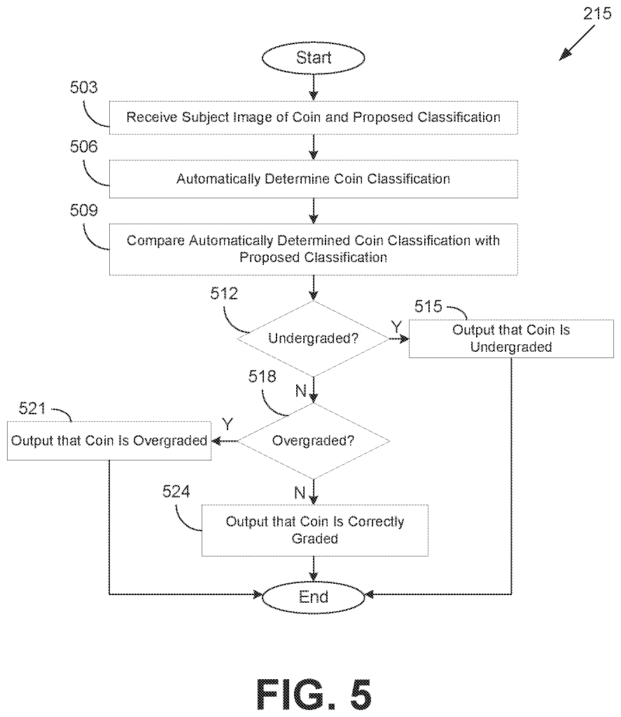

Turning now to FIG. 5, shown is a flowchart that provides one example of the operation of another portion of the coin assessment application 215 according to various embodiments. It is understood that the flowchart of FIG. 5 provides merely an example of the many different types of functional arrangements that may be employed to implement the operation of the portion of the coin assessment application 215 as described herein. As an alternative, the flowchart of FIG. 5 may be viewed as depicting an example of elements of a method implemented in the computing environment 203 (FIG. 2) according to one or more embodiments.

Beginning with box 503, the coin assessment application 215 receives a subject image of a coin and a proposed classification or grade. For example, the coin depicted in the subject image may have been assigned the proposed classification by a grading service.

In box 506, the coin assessment application 215 automatically determines a coin classification using analysis performed by a coin grading machine learning model 227 (FIG. 2) as described in the flowchart of FIG. 3. In box 509, the coin assessment application 215 compares the automatically determined coin classification with the proposed classification associated with the coin. In this way, the coin assessment application 215 may determine that the coin is undergraded, overgraded, or correctly graded.

In box 512, the coin assessment application 215 determines whether the coin was undergraded by the proposed classification. If the coin appears to be undergraded, the coin assessment application 215 moves to box 515 and outputs that the coin appears to be undergraded. The coin assessment application 215 may also output the automatically determined coin classification. Thereafter, the operation of the portion of the coin assessment application 215 ends.

If the coin assessment application 215 determines that the coin is not undergraded, the coin assessment application 215 continues to box 518. In box 518, the coin assessment application 215 whether the coin was overgraded by the proposed classification. If the coin appears to be overgraded, the coin assessment application 215 moves to box 521 and outputs that the coin appears to be overgraded. The coin assessment application 215 may also output the automatically determined coin classification. Thereafter, the operation of the portion of the coin assessment application 215 ends.

If the coin assessment application 215 determines that the coin is not overgraded, the coin assessment application 215 continues to box 524. In box 524, the if the coin assessment application 215 determines that the coin is not undergraded, the coin assessment application 215 outputs that the coin has been correctly graded. Thereafter, the operation of the portion of the coin assessment application 215 ends.

The flowcharts of FIGS. 3-5 show the functionality and operation of an implementation of portions of the coin assessment application 215. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowcharts of FIGS. 3-5 show a specific order of execution, it is understood that the order of execution may differ from that which is depicted. For example, the order of execution of two or more blocks may be scrambled relative to the order shown. Also, two or more blocks shown in succession in FIGS. 3-5 may be executed concurrently or with partial concurrence. Further, in some embodiments, one or more of the blocks shown in FIGS. 3-5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

The embodiments of the computing environment 203 described herein can be implemented in hardware, software, or a combination of hardware and software. If embodied in software, the functions, steps, and elements can be implemented as a module or set of code that includes program instructions to implement the specified logical functions. The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

The embodiments of the computing environment 203 can be implemented by at least one processing circuit or device and at least one memory circuit or device. Such a processing circuit can include, for example, one or more processors and one or more storage or memory devices coupled to a local interface. The local interface can include, for example, a data bus with an accompanying address/control bus or any other suitable bus structure. The memory circuit can store data or components that are executable by the processing circuit.

If embodied as hardware, the functions, steps, and elements can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, and/or programmable logic devices (e.g., field-programmable gate array (FPGAs), and complex programmable logic devices (CPLDs)).

Also, one or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims. If a component is described as having “one or more” of the component, it is understood that the component can be referred to as “at least one” component.

The terms “first.” “second,” etc. are used only as labels, rather than a limitation for a number of the objects. It is understood that if multiple components are shown, the components may be referred to as a “first” component, a “second” component, and so forth, to the extent applicable.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y. or at least one of Z to each be present.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A computer-implemented method for automatically grading coins, the method comprising:
training a machine learning model based at least in part on a plurality of first images respectively depicting a plurality of coins of a particular type, individual ones of the plurality of coins being manually assigned a respective coin classification;
receiving a second image depicting a different coin of the particular type;
performing an analysis of the second image based at least in part on the machine learning model; and
automatically assigning a particular coin classification to the different coin based at least in part on the analysis of the second image.

2. The computer-implemented method of claim 1, further comprising:
determining a date of the different coin based at least in part on the second image; and
wherein automatically assigning the particular coin classification to the different coin is further based at least in part on the date.

3. The computer-implemented method of claim 1, further comprising:
determining a level of wear of the different coin based at least in part on the second image; and
wherein automatically assigning the particular coin classification to the different coin is further based at least in part on the level of wear.

4. The computer-implemented method of claim 1, further comprising:
determining a hue-saturation-lightness (HSL) value of the different coin based at least in part on the second image; and
wherein automatically assigning the particular coin classification to the different coin is further based at least in part on the HSL value.

5. The computer-implemented method of claim 1, wherein the particular coin classification is a grade on the Sheldon coin grading scale.

6. The computer-implemented method of claim 1, wherein the particular coin classification indicates at least one of: toning, color, or eye appeal.

7. The computer-implemented method of claim 1, wherein the particular type is one or more of: a penny, a quarter, or a dollar coin.

8. The computer-implemented method of claim 1, further comprising at least one of:
automatically identifying the particular type of the different coin by performing an initial analysis of the second image;
automatically identifying a particular variety of the particular type of the different coin by performing an initial analysis of the second image; or
automatically identifying a mint error on the different coin by performing an initial analysis of the second image.

9. The computer-implemented method of claim 1, further comprising determining a correlation between the respective coin classification and a ratio of local maxima of harmonics in each of the plurality of first images.

10. The computer-implemented method of claim 1, wherein performing the analysis of the second image further comprises:
applying a transform to straighten a feature of the different coin; and
cropping the second image around the feature of the different coin.

11. The computer-implemented method of claim 10, further comprising performing a Fourier transform on the cropped second image.

12. The computer-implemented method of claim 1, wherein performing the analysis of the second image further comprises:
identifying text from the different coin in the second image; and
cropping the second image around the text.

13. The computer-implemented method of claim 1, wherein the plurality of first images and the second image depict a coin obverse.

14. The computer-implemented method of claim 1, wherein the plurality of first images and the second image depict a coin reverse.

15. The computer-implemented method of claim 1, wherein the machine learning model uses at least one of: a K-nearest neighbors algorithm, a support vector machine, or a neural network.

16. A computer-implemented method for automatically verifying coin classifications, the method comprising:
training a machine learning model based at least in part on a plurality of first images respectively depicting a plurality of coins of a particular type, individual ones of the plurality of coins being manually assigned a respective coin classification;
receiving a second image depicting a different coin of the particular type, the second image being associated with a proposed classification;
performing an analysis of the second image based at least in part on the machine learning model; and
automatically determining whether the different coin is correctly classified with the proposed classification based at least in part on the analysis.

17. The computer-implemented method of claim 16, further comprising:
determining that the different coin is incorrectly classified; and
outputting an automatically determined classification based at least in part on the analysis, the automatically determined classification differing from the proposed classification.

18. The computer-implemented method of claim 16, wherein automatically determining whether the different coin is correctly classified with the proposed classification is based at least in part on a confidence level associated with the analysis.

19. A system for automatically grading coins, comprising:
at least one computing device configured to at least:
train a machine learning model based at least in part on a plurality of first images respectively depicting a plurality of coins, individual ones of the plurality of coins being manually assigned a respective coin classification;
receive a second image depicting a different coin;
perform an analysis of the second image based at least in part on the machine learning model; and
automatically assign a particular coin classification to the different coin based at least in part on the analysis of the second image.

20. The system of claim 19, further comprising determining whether a proposed coin classification is incorrect based at least in part on the particular coin classification and a confidence level associated with the analysis.
